(19) United States
(12) Patent Application Publication
(10) Pub. No.: US 2024/0247930 A1
(43) Pub. Date: Jul. 25, 2024

(54) RETROGRAPHIC SENSING

(71) Applicant: GelSight, Inc., Waltham, MA (US)

(72) Inventors: Janos Rohaly, Concord, MA (US); Micah Kimo Johnson, Nashua, NH (US); Jay William Anseth, Canton, MA (US)

(21) Appl. No.: 18/627,060

(22) Filed: Apr. 4, 2024

Related U.S. Application Data
(63) Continuation of application No. PCT/US22/46129, filed on Oct. 7, 2022.
(60) Provisional application No. 63/253,694, filed on Oct. 8, 2021.

(51) Int. Cl. G01B 11/30; G02B 3/14; G02B 26/00; G03B 15/06; G03B 35/02

(52) U.S. Cl. CPC G01B 11/303; G02B 3/14; G02B 26/004; G03B 15/06; G03B 35/02

(57) ABSTRACT

A topographical measurement system includes a rigid optical element and a clear, elastomeric sensing surface configured to capture high-resolution topographical data from a measurement surface. The rigid optical element and elastomeric sensing surface may be configured as a removable cartridge that can be removed and replaced as a single, integral component. An optical diffraction element or similar optical system may be used to create a three-dimensional illumination pattern within an imaging volume so that, when the system is placed for use on a surface, the illumination within the imaging volume facilitates computational reconstruction of a surface contacting the elastomeric sensing surface and spatially intersecting the imaging volume. The techniques described herein may also or instead be applied to a non-cartridge based imaging system, where other advantages such as short length, compact size, improved illumination, and the use of supplemental and complementary depth measurement techniques, can also improve a measurement system.

### CROSS-REFERENCE TO RELATED APPLICATIONS

This application is a bypass continuation that claims priority to International Patent App. No. PCT/US22/46129 filed on Oct. 7, 2022, which claims priority to U.S. Prov. Patent App. No. 63/253,694 filed on Oct. 8, 2021, where the entire content of each of the foregoing is hereby incorporated by reference.

### TECHNICAL FIELD

The present disclosure generally relates to retrographic sensing systems.

### BACKGROUND

There remains a need for improved surface topography measurement systems using retrographic sensors and/or other imaging techniques.

### SUMMARY

A topographical measurement system includes a rigid optical element and a clear, elastomeric sensing surface configured to capture high-resolution topographical data from a measurement surface. The rigid optical element and elastomeric sensing surface may be configured as a removable cartridge that can be removed and replaced as a single, integral component. An optical diffraction element or similar optical system may be used to create a three-dimensional illumination pattern within an imaging volume so that, when the system is placed for use on a surface, the illumination within the imaging volume facilitates computational reconstruction of a surface contacting the elastomeric sensing surface and spatially intersecting the imaging volume. The techniques described herein may also or instead be applied to a non-cartridge based imaging system, where other advantages such as short length, compact size, improved illumination, and the use of supplemental and complementary depth measurement techniques, can also improve a measurement system.

In one aspect, a device disclosed herein includes an imaging volume defining a three-dimensional field of view for capturing images; a camera having an imaging axis passing through the imaging volume; a plane intersecting the imaging volume and perpendicular to the imaging axis of the imaging device; a laser providing illumination including fixed-focus, coherent light; a diffractive optical element positioned to receive the illumination from the laser on a first surface, the first surface of the diffractive optical element including micropatterned structures to create a three-dimensional illumination pattern within the imaging volume from a second surface opposing the first surface; a liquid lens configured to focus the camera on a target surface of an object within the imaging volume; an imaging cartridge removably and replaceably coupled to the device, the imaging cartridge including a rigid substrate and an optical element having a soft, optically clear elastomer on a first side facing the camera and a thin, reflective coating on a second side opposing the camera; and a processor configured by instructions stored in a memory to receive an image of light from the pattern reflected by the thin, reflective coating of the elastomeric optical element as it deforms to the surface of the object within the imaging volume, the processor further configured by instructions stored in the memory to calculate a quantitative surface topography of the surface based on the image.

In another aspect, a device disclosed herein includes an imaging volume within a conformable imaging medium defining a three-dimensional field of view for capturing images; an imaging device having an imaging axis passing through the imaging volume; a plane intersecting the imaging volume and perpendicular to the imaging axis of the imaging device; a light source providing illumination; and an optical element positioned and structured to receive the illumination from the light source on a first surface and create a pattern within the imaging volume from a second surface opposing the first surface, the second surface at an angle to the plane intersecting the imaging volume.

The second surface may be at an oblique angle to the plane intersecting the imaging volume. The optical element may include a diffractive optical element, the device further comprising a second diffractive optical element positioned and structured to create a second pattern within the imaging volume for a different location about a perimeter of the imaging volume than the diffractive optical element. The device may include a processor configured to receive an image of light from the pattern reflected by a surface within the three-dimensional field of view and to calculate a quantitative surface topography of the surface based on the image. The surface may include a deformable surface of the conformable imaging medium intersecting the imaging volume.

The device may include a multi-view imaging system configured to calculate a quantitative surface topography of a surface within the three-dimensional field of view based on images of the surface from two or more different perspectives. The device may include a multi-view imaging system that resolves a three-dimensional shape of the surface using a second spectral band having wavelengths non-overlapping with a first spectral band of the light source. The device may include a second light source providing illumination in the second spectral band.

In one aspect, the device may include an imaging cartridge. The imaging cartridge may be positioned at least partially within the imaging volume. The imaging cartridge may include the conformable imaging medium on a first side facing the imaging device and an optical coating on a second side opposing the imaging device. The conformable imaging medium may include a soft, optically clear elastomer. The conformable imaging medium may include an optically clear fluid. The optical coating may include a visible texture or a visible pattern. The optical coating may be a thin, reflective coating. The optical coating may change color in response to deformation of the second side of the imaging cartridge. In once aspect, the imaging cartridge may include a retrographic sensor positioned within the imaging volume. The imaging cartridge may also or instead include an elastomeric element positioned within the imaging volume.

In one aspect, the device may include a liquid lens configured to focus the imaging device on a surface within the imaging volume, e.g., within a plane or other two-dimensional slice through the imaging volume. More generally, the device may include one or more lenses configured to change a focus along the imaging axis through the imaging volume, e.g., to facilitate three-dimensional data acquisition from within the imaging volume.

In one aspect, the optical element may include a diffractive optical element having micropatterned structures configured to create the pattern within the imaging volume from the light from the light source incident on the first surface. The optical element may include metasurfaces configured to create the pattern within the imaging volume from the light incident on the first surface. The second surface of the optical element may have an oblique angle of at least thirty degrees to the plane intersecting the imaging volume. The light form the optical element may be incident on the plane at between fifty and seventy degrees. The pattern may includes a three-dimensional pattern varying along the imaging axis within the imaging volume. The pattern may include a first plurality of features closely spaced within the plane and a second plurality of features visually distinguishable from the first plurality of features and more distantly spaced within the plane. The pattern may include a first plurality of features and a second plurality of features collectively forming a regular geometric pattern within the plane, the second plurality of features forming visually distinguishable anchor points within the pattern. The pattern may include a first plurality of features closely spaced to provide high resolution detection of depth within the imaging volume and a second plurality of features placed sufficiently far apart within the plane through the imaging volume avoid intersections along the imaging axis within the imaging volume during a maximum expected deformation of a contact surface of an elastomeric optical element within the imaging volume. The pattern may include a first plurality of features closely spaced to provide high resolution detection of depth within the imaging volume and a second plurality of features placed sufficiently far apart within the plane through the imaging volume to avoid intersections along the imaging axis within the imaging volume during a maximum possible deflection of a contact surface of an elastomeric optical element within the imaging volume. The pattern may include a plurality of features including one or more of lines, dots, and polygons.

In another aspect, the light source may provide light having a coherent, fixed focus. The light source may also or instead include a laser. The light source may for example, be a collimated light source.

In another aspect, there is disclosed herein a device including an imaging volume within a conformable imaging medium defining a three-dimensional field of view for capturing images; and an imaging system configured to calculate a quantitative surface topography of a target surface intersecting the imaging volume and displacing the conformable imaging medium within the three-dimensional field of view using two or more imaging modalities including at least photometric stereo and multi-view imaging.

The imaging system may employ a combination of multi-view three-dimensional reconstruction and photometric three-dimensional reconstruction using a projected texture reflected by a surface of the conformable imaging medium deformed by the target surface intersecting the imaging volume. The imaging system may employ a combination of multi-view three-dimensional reconstruction and photometric three-dimensional reconstruction using a texture on a surface of the imaging medium deformed by the target surface intersecting the imaging volume.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1 shows an imaging system.

FIG. 2 shows a cross-section of an imaging cartridge for an imaging system.

FIG. 3 shows a top view of an imaging cartridge.

FIG. 4 is a perspective view of an imaging cartridge and a housing for an imaging system.

FIG. 5 is a side view of an imaging cartridge for an imaging system.

FIG. 6 is a perspective view of an imaging cartridge.

FIG. 7 is a perspective view of an imaging cartridge.

FIG. 8 is a perspective view of an imaging cartridge.

FIG. 9 is a perspective view of an imaging cartridge.

FIG. 10 is a side view of the imaging cartridge of FIG. 9.

FIG. 11 shows a robotic system using an imaging cartridge.

FIG. 12 shows an imaging system with an imaging cartridge.

FIG. 13 shows an imaging system with an imaging cartridge.

FIG. 14 shows a cutaway view of an imaging system with an imaging cartridge.

FIG. 15 shows a cross section of a diffractive optical element angled to the imaging axis of an imaging system.

FIG. 16 shows an illumination pattern.

FIG. 17 shows a cartridge for use in an imaging system.

FIG. 18 shows a substrate for a cartridge for use in an imaging system.

FIG. 19 shows an overmolded coating for an imaging cartridge.

### DETAILED DESCRIPTION

All documents mentioned herein are incorporated by reference in their entirety. References to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

The devices, systems, and methods described herein may include, or may be used in conjunction with, the teachings of U.S. patent application Ser. No. 14/201,835 filed on Mar. 8, 2014, U.S. Pat. No. 9,127,938 granted on Sep. 8, 2015, and U.S. Pat. No. 8,411,140 granted on Apr. 2, 2013. The entire contents of each of the foregoing is hereby incorporated by reference. In certain aspects, the devices, systems, and methods described herein may be used to provide readily interchangeable imaging cartridges with retrographic sensors or the like for use in handheld or quantitative topographical or three-dimensional measurement systems. However, the devices, systems, and methods described herein may also or instead be included on, or otherwise used with, other systems. For example, the systems described herein may be useful for, e.g., robotic end effector systems, such as for part identification and pose estimation, force feedback, robotic surgery, medical examination, and the like as well as other systems and applications where one or more of touch, tactile sensing, surface topography, or three-dimensional measurements are necessary or helpful.

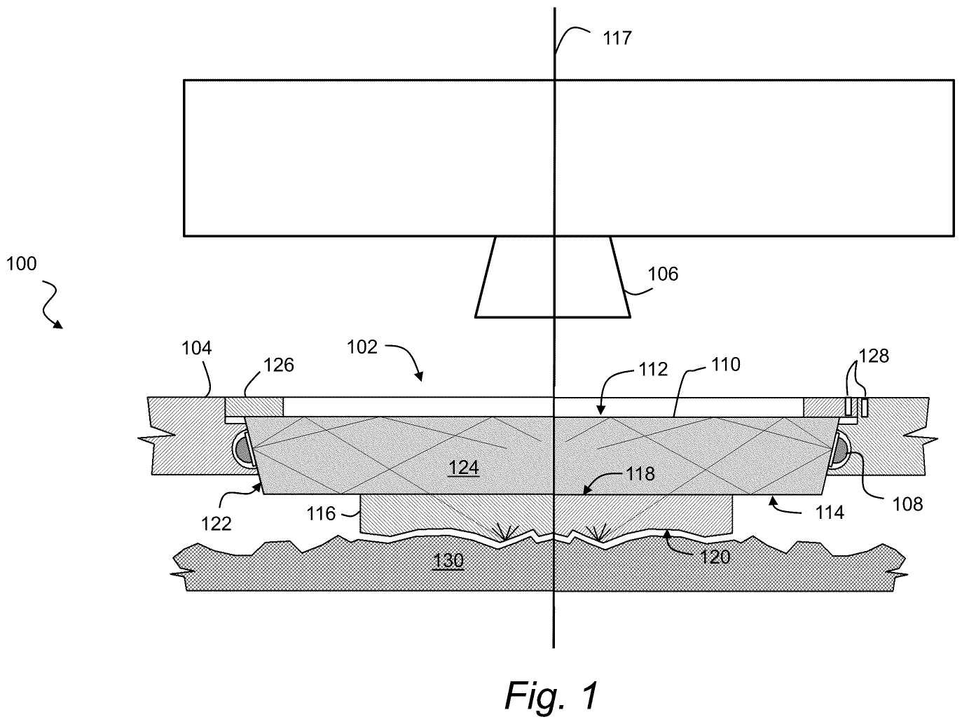

FIG. 1 shows an imaging system. In general, the imaging system 100 may be any system for quantitative or qualitative topographical measurements and/or visualization, such as a retrographic sensor system using one or more retrographic sensors, or any of the other imaging systems described in the documents identified above. For example, quantitative data may include an image, a surface normal map, a height map of three-dimensional topography, a force map, an elasticity map, or other measure of softness/hardness of the target surface, and so forth. The imaging system 100 may include an imaging cartridge 102 configured as a removable and replaceable cartridge for the imaging system 100, along with a fixture 104 for retaining the imaging cartridge 102. The fixture 104 may have a predetermined geometric configuration relative to the imaging system 100, e.g., relative to an imaging device 106 such as a camera and an illumination source 108 such as one or more light emitting diodes or other light sources, so that the imaging cartridge 102, when secured in the fixture 104, has a known position and orientation relative to the camera and light source(s). This enforced geometry advantageously permits re-use of calibration data for an imaging cartridge 102, and reliable, repeatable positioning of the imaging cartridge 102 within an optical train of the imaging system 100.

It should be appreciated that, while the following description emphasis the use of a removable imaging cartridge 102 with a retrographic sensor, the imaging cartridge 102 or portions thereof may instead be integral to the imaging system 100 in a generally non-removable manner. Thus, some of the advantages of the systems and methods described herein may apply as well to an imaging system 100 as generally described herein that does not include any removable imaging cartridge 102, but instead incorporates some or all of the components of the imaging cartridge 102 into a body of the imaging system 100. In one aspect, portions such as a rigid substrate may be integrated into the body of the imaging system 100, while other portions such as a portion that contacts target surfaces may be removable and replaceable to permit reuse of the imaging system 100 after the contact surface has become contaminated or damaged with use.

The imaging cartridge 102 may include an optical element 110 formed at least in part of a rigid, optically transparent material such as glass, polycarbonate, acrylic, polystyrene, polyurethane, an optically transparent epoxy, or any other material with suitable mechanical and optical properties for use in the systems described herein. In one aspect, a silicone such as a hard platinum cured silicone, or any other optical quality polymer may also or instead be used. As a further advantage, a layer 116 of optically transparent conformable material may be formed of a material that facilitates direct bonding to the rigid material of the optical element 110 without any use of adhesives. For example, where the optical element 110 is formed of a hard platinum cured silicone, the layer 116 of conformable, optically transparent material may be formed of an elastomer such as a soft platinum cured silicone and bonded to the hard silicone without the use of adhesives. The optical element 110 may include a first surface 112 including a region with an optically transparent surface for capturing images through the optical element 110, e.g., by the imaging device 106. The optical element 110 may also include a second surface 114 opposing the first surface 112, with a center axis 117 passing through the first surface 112 and the second surface 114.

In general, the first surface 112 may have optical properties suitable for conveying an image from the second surface 114 through the optical element 110 to the imaging device 106. To support this function, the first surface 112 may include any suitable light shaping features, such as a curved surface providing a lens to optically magnify an image from the second surface 114. In another aspect, the first surface 112 may include an aspheric surface shaped to address spherical aberrations or other optical aberrations in an image captured through the optical element 110 from the second surface 114. The first surface 112 may also or instead include a freeform surface shaped to reduce or otherwise mitigate geometric distortion in an image captured through the optical element 110. Imaging through a thick media may generally lead to spherical aberration with a magnitude depending on a numerical aperture of the imaging system 100 (or more specifically here, the imaging lens 106). Thus, the first surface 112 of the optical element 110 may be curved or otherwise adapted to address such spherical aberrations (and other higher order aberrations) resulting from propagation of focused ray bundles through thick media. More generally, the first surface 112 may include any shape or surface treatment suitable to focus, shape, or modify the image in a manner that supports capture of topographical data using the optical element 110. The second surface 114 may also or instead be modified to improve image capture. For example, the second surface 114 of the optical element 110 may include a convex surface extending from the optical element 110 (e.g., toward the target surface 130 being imaged) in order to magnify or otherwise shape an image conveyed from the target surface 130 to the imaging device 106.

The optical element 110 may generally serve a number of purposes in an imaging system 100 as contemplated herein. In one aspect, the optical element 110 serves as a rigid body to transfer pressure relatively uniformly across a target surface 130 when capturing images. Specifically, the body of the optical element 110 may apply a substantially uniform pressure on a clear substrate gel such that a reflective membrane coating on the other side of the clear substrate conforms to the measured surface topography. In one aspect, the optical element 110 may provide a grazing or shallow angle illumination. The optical element 110 may also or instead provide directional dark field illumination. To this end, sufficiently thick optical material may function as a light guide to provide controlled, uniform, and close to collimated dark field or grazing illumination of the reflective membrane surface from distinct directions (e.g., when one LED segment of the illumination source 108 is on) or from all around (e.g., when all LED segments of the illumination source 108 are on). The latter configuration may be useful, for example, when different colored LEDs are used to multiplex optical channels for multi-spectral photometric stereo in which each color is associated with a specific illumination direction.

A layer 116 of optically transparent material such as an elastomer or other conformable material may be disposed on the second surface 114 and attached to the second surface 114 using any suitable means, such as any of those described herein. In general, the layer 116 may be formed of an elastomer or any other relatively conformable material that is capable of deforming to match a topography of a target surface 130 so that the complementary shape formed in the layer 116 can be optically captured through an opposing surface of the layer 116. Thus, for example, the layer 116 may be formed of a gel (such as an optically clear gel), a fluid (such as an optically clear fluid), or the like. Where a fluid such as a liquid or gas is used, the layer 116 may include a membrane such as an elastic or deformable membrane that can contain the fluid while permitting conformance to a target surface of interest. In terms of pliability, an elastomer or other material or combination of materials with a Shore OO durometer value of about 5-60 may usefully serve as the layer 116 contemplated herein. In general, a first side 118 of the layer 116 that is adjacent to the second surface 114 of the optical element 110 may have an index of refraction that is matched to the index of refraction of the second surface 114. It will be appreciated that, as used herein when referring to indices of refraction, the term “matched” does not require identical indices of refraction. Instead, the term “matched” generally means having indices of refraction that are sufficiently close to transmit images through a corresponding interface between two materials for capture by the imaging device 106. Thus, for example, acrylic has an index of refraction of about 1.49 while polydimethylsiloxane has an index of refraction of about 1.41 and these materials are sufficiently matched that they can be placed adjacent to one another and can be used to transmit images sufficient for quantitative or qualitative topographical measurements as contemplated herein.

A second side 120 of the layer 116 may be configured to conform to a target surface 130 while providing a surface facing the imaging device 106 that facilitates topographical imaging and measurements by the imaging system 100. The second side 120 may for example, include an opaque or reflective coating, or more generally, any optical coating with a predetermined reflectance suitable for supporting topographical imaging as contemplated herein. For example, the optical coating may include a visible texture or a visible pattern that can be imaged by an imaging system and analyzed, e.g. to recover a shape of the second side 120 of the layer 116. The optical coating may also or instead have optical properties that change in response to deformation. For example, the optical coating may change color, transparency, reflectivity, or texture in response to deformation. To the extent that these changes can be visually captured by an imaging system, they provide a basis for estimating a deformation field along the second side 120 from which three-dimensional shape information may be recovered.

In general, this coating can facilitate capture of images through the optical element 110 that are independent of optical properties of the target surface 130 such as color, translucence, gloss, specularity, and the like that might otherwise interfere with optical imaging. In one aspect, the second side 120 may include a convex surface extending away from the optical element 110 (e.g., toward the target surface 130). This geometric configuration can provide numerous advantages such as facilitating imaging of surfaces with large, aggregate concave shapes, and mitigating an accumulation of air bubbles within the field of view when the imaging cartridge 102 is initially placed in contact with a target surface 130.

A sidewall 122 may be formed around an interior 124 of the optical element 110 extending from the first surface 112 to the second surface 114. In general, the sidewall 122 may include one or more light shaping features configured to control an illumination of the second surface 114 through the sidewall 122, e.g., from the illumination source 108. The sidewall 122 may assume a variety of geometries with useful light shaping features, e.g., to steer light at desirable angles and uniformity into and through the optical element 110. For example, the sidewall 122 may include a continuous surface forming a frustoconical shape between two circles formed in the first surface 112 and the second surface 114. The sidewall 122 may also or instead include a truncated hemisphere between some or all of the region between the first surface 112 and the second surface 114. In another aspect, the sidewall 122 may include two or more discrete planar surfaces arranged into a regular or irregular polygonal geometry such as a hexagon or an octagon about the center axis 117. In this later embodiment with planar surfaces, each such surface may have an illumination source 108 such as one or more light emitting diodes adjacent thereto in order to provide side lighting as desired through the optical element 110. It should be understood that a plane may also serve as a light shaping feature where the plane refracts light rays and/or otherwise controls illumination in a desired manner within an imaging volume of the system 100.

Other light shaping features may also or instead be used with surfaces of the optical element such as the sidewall 122 or the first surface 112, e.g., to focus or steer incident light from the illumination source 108, or to control reflection of light within the optical element 110 and/or the layer 116 of optically transparent elastomer. For example, the light shaping feature may include a diffusing surface to diffuse point sources of incoming light along an exterior surface of the optical element 110. This may for example, help to diffuse light from individual light emitting diode elements in the illumination source 108, and/or to provide a more uniform illumination field from a planar surface of the sidewall 122. The sidewall 122 or some other exterior surface of the optical element 110 may also or instead include a polished surface to refract incoming light into the optical element 110. It will be appreciated that diffusing and reflecting surfaces may also be used in various combinations to generally shape illumination within the optical element 110. The sidewall 122 or other surface of the optical element 110 may also or instead include a curved surface, e.g., forming a lens to focus or steer incident light into the optical element 110 as desired.

In another aspect, the sidewall 122 or other surface of the optical element 110 may include a neutral density filter with graduated attenuation to compensate for a distance to the second surface 114 where the optical element interfaces with the layer 116 of conformable material. More specifically, in order to avoid over-illumination of regions of the second surface 114 near a light source, and/or under-illumination of regions of the second surface 114 away from a light source, (e.g., closer to the center axis 117 or an opposing side of the optical element 110), the surface of the optical element 110 may include a filter providing broadband attenuation with a neutral density filter that provides greater attenuation in areas closer to the second surface 114 and less attenuation in areas farther from the second surface 114. In this manner, light rays directly illuminating the second surface 114 at a downward angle adjacent to the sidewall 122 may be more attenuated than other light rays exiting the illumination source 108 toward the center of the second surface 114. This attenuation may for example, be continuous, discrete, or otherwise graduated to provide generally greater attenuation closer to the sidewall 122 or otherwise balance illumination within the field of view.

In another aspect, the light shaping feature may include one or more color filters, which may usefully be employed, e.g., to correlate particular colors to particular directions of illumination within the optical element 110, or otherwise control use of colored illumination from the illumination source 108. Where the imaging system uses wavelength-multiplexed imaging, color filters on the sidewalls may also reduce stray lighting within the cartridge by selectively reflecting or transmitting frequency ranges of interest. In another aspect, the light shaping feature may include a non-normal angle of the sidewall 122 to the second surface 114. For example, as illustrated in FIG. 1, the sidewall 122 is angled away from the second surface 114 to form an obtuse angle therewith. This approach may advantageously support indirect illumination of the second surface 114, e.g., by total internal reflection of light off of the first surface 112 and into the optical element 110. In another aspect, the sidewall 122 may be angled toward the second surface to provide an acute angle therewith, e.g., in order to support greater direct illumination of the second surface 114. These approaches may be used alone or in combination to steer light as desired into and through the optical element 110.

The light shaping feature may also or instead include a geometric feature such as a focusing lens, planar regions, or the like positioned on a surface of the optical element 110 to direct incident light as desired. Other optical elements may also or instead usefully be formed onto or into the sidewall 122 or other surface regions of the optical element 110. For example, the light shaping feature may include an optical film such as any of a variety of commercially available films for filtering, attenuating, polarizing, or otherwise shaping the incident light. The light shaping feature may also or instead include a micro-lens array or the like to steer or focus incident light from the illumination source 108. The light shaping feature may also or instead include a plurality of micro-replicated and/or diffractive optical features such as lenses, gratings, or the like. For example, a microstructured sidewall 122 may include, e.g., microimaging lenses, lenticulars, microprisms, and so on as light shaping features to steer light from the illumination source 108 into the optical element 110 in a manner that improves imaging of topographical variations to the imaging surface of the imaging cartridge 102 on the second side 120 of the layer 116 of optically transparent material. For example, microstructured features may facilitate shaping the illumination pattern to provide uniform light distribution across the measured field, reduce the reflection of light back into or out of the optical element 110, and so forth. Microstructuring may for example, be imposed during injection molding of the optical element 110, or by applying an optical film with the desired microstructure to the side surface. For example, a commercially suitable optical film includes Vikuiti™, an advanced light control film (ALCF) sold by 3M.

A mechanical key 126 may be disposed on an exterior of the optical element 110 for enforcing a predetermined position of the optical element 110 (and more generally, the imaging cartridge 102) within the fixture 104 of the imaging system 100. The mechanical key 126 may for example, include at least one radially asymmetric feature about the center axis 117 for enforcing a unique rotational orientation of the optical element 110 within the fixture 104 of the imaging system 100. The mechanical key 126 may also or instead include any number of mechanical elements or the like suitable for retaining the optical element 110 in a predetermined orientation within the imaging system 100. The mechanical key 126 may for example include a matched geometry between the optical element 110 and the fixture 104. For example, the mechanical key 126 may include a cylindrical structure extending from the optical element 110, or an elliptical prism or the like, which may usefully enforce a rotational orientation concurrently with position.

In one aspect, the mechanical key 126 may include one or more magnets 128, which may secure the optical element 110 in the fixture 104 of the imaging system. The magnets 128 may be further encoded via positioning and/or polarity to ensure that the optical element 110 is only inserted in a particular rotational orientation about the center axis 117. The mechanical key 126 may also or instead include a plurality of protrusions including at least one protrusion having a different shape than other ones of the plurality of protrusions for enforcing the unique rotational orientation of the optical element 110 about the center axis 117 within the fixture 104 of the imaging system 100. The mechanical key 126 may also or instead include at least three protrusions (e.g., exactly three protrusions) shaped and sized to form a kinematic coupling with the fixture 104 of the imaging system 100. The mechanical key 126 may also or instead include features such as a flange, a dovetail, or any other mechanical shapes or features to securely mate the optical element 110 to the fixture 104 in a predetermined position and/or orientation. A number of specific mechanical keying systems are discussed herein with reference to specific optical element designs and configurations.

Surfaces of the imaging cartridge 102 may be further treated as necessary or helpful for use in an imaging system 100 as contemplated herein. For example, regions of the top, side, and bottom surfaces of the optical element 110 or other portions of the imaging cartridge 102 may be covered with a light absorbing layer, such as a black paint, e.g., to contain light from the illumination source 108 or to reduce infiltration of ambient light.

One challenge to securing a flexible elastomer (in the layer 116) to a rigid surface such as the optical element 110 may be delamination, which can result from shear forces and other edge effects after repeated image capture, particularly where the target surface 130 tends to adhere to the elastomer. To address this issue, the optical element 110 and the layer 116 of clear elastomer may be formed as a cartridge that is provided for end users as an integral, removable, and replaceable device. An end user can quickly and easily replace this cartridge as required, or in order to substitute in an imaging cartridge 102 with different optical properties, e.g., for a different imaging application, resolution, or the like. At the same time, concurrent replacement of the optical element 110 with the layer 116 may permit the use of more robust means for mechanically securing the layer 116 of elastomer to the optical element 110. As a significant advantage, this approach can mitigate challenges to the end user associated with exchanging the layer 116 of elastomer, such as the introduction of contaminants or air bubbles between the layer 116 of elastomer and the optical element 110.

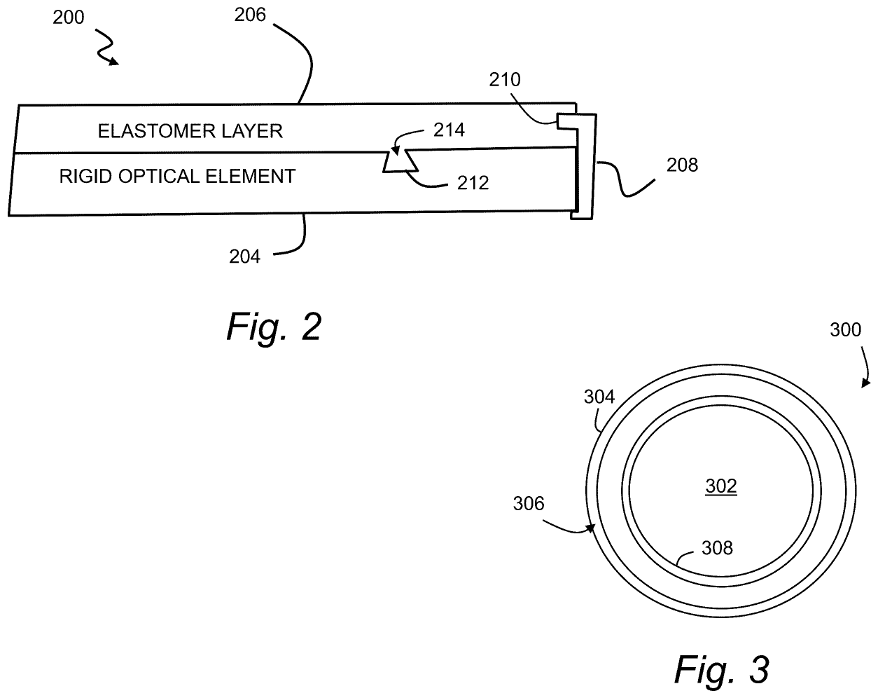

FIG. 2 shows a cross-section of an imaging cartridge for an imaging system. In general, the imaging cartridge 200 may include a layer 206 of optically transparent elastomer coupled to an optical element 204. This may include any of the layers of elastomer and optical elements described herein. In general, the layer 206 of elastomer may be coupled to the optical element 204 using any suitable retaining structure. Because the layer of elastomer and the optical element 204 are provided to end users as an integrated cartridge, as distinguished from other systems of the prior art, which required periodic manual replacement of the layer 116 of elastomer, a wider variety and combination of techniques may be used to securely retain the layer 206 adjacent to the optical element 204.

The retaining structure may include any tackifier or other adhesive, glue, epoxy, or the like, including any of the adhesives described herein. Where the imaging cartridge 200 is fabricated for use as an integral, consumable product, it should not generally be necessary to remove and replace the layer 206 of elastomer, and the layer 206 may be affixed to the optical element 204 with a relatively strong, rigid epoxy. In one aspect, the retaining structure may include an index-matched optical adhesive disposed between the layer 206 of optically transparent elastomer and the surface of the optical element 204. As discussed above, index-matched in this context refers to any indices of refraction sufficiently close to support optical transmission of a useful image across the corresponding interface.

The retaining structure may also include a retaining ring 208 about a perimeter of the layer 206 of optically transparent elastomer mechanically securing the perimeter to the surface of the optical element 204. The retaining ring 208 may traverse the entire perimeter or one or more portions of the perimeter. While the retaining ring 208 may optionally extend over a top, functional surface of the layer 206 of elastomer, this may interfere with placement of the imaging cartridge 200 on a target surface, particularly if the target surface is substantially planar. Thus, in one aspect, the retaining ring 208 may usefully be positioned within an indent 210 or the like formed within an edge of the layer 206, or an indent 210 created by a mechanical force of the retaining ring 208 against the more conformable elastomer of the layer 206. It will be appreciated that the retaining ring 208 may have any shape, corresponding generally to a shape of a perimeter of the layer 206 of elastomer such as a polygon, ellipse, and so forth. Thus, the term “ring” as used in this context, is not intended to suggest or require a circular or rounded shape. Further, while a retaining ring 208 is described, the retaining structure may also or instead include any number of tabs, protrusions, flanges, or the like extending over or into the layer 206 to mechanically secure the perimeter of the layer 206 in contact with the optical element 204.

The retaining structure may also or instead include a recess 212 within the surface of the optical element, and a corresponding protrusion 214 in the layer 206 of optically transparent elastomer that extends into the recess 212. The recess 212 may include a groove or other shape suitable for receiving the protrusion 214. In one aspect, the recess 212 may be dovetailed to provide a wider region away from the surface of the layer 206 in order to improve the mechanical strength of the bond formed between the layer 206 of elastomer and the optical element 204. More generally, the recess 212 may be structurally configured to retain the layer 206 on the surface of the optical element 204. In this manner, a mechanical coupling may be formed between the layer 206 and the optical element 204, e.g., to replace or augment a coupling formed by adhesives, a retaining ring 208, or any other retaining structures.

In order to fill the recess 212 during manufacturing, the layer 206 of elastomer may be liquid-formed or thermo-formed into the recess 212 using any suitable, optically transparent elastomer. Suitably shaped, deformable elastomers may also or instead be press-fit or otherwise assembled into the recess 212. However, by applying the elastomer as a liquid and then curing the elastomer, the layer 206 of elastomer may more fully fill the void space of the recess 212 and provide a stronger mechanical bond to the optical element 204.

FIG. 3 shows a top view of an imaging cartridge. The imaging cartridge 300 may be an imaging cartridge such as any of the imaging cartridges or similar components described herein. In general, the imaging cartridge 300 may include a layer 302 of a conformable elastomer used to contact and capture images of target surfaces. The layer 302 may be secured to an optical element through a variety of retaining structures such as a retaining ring 304 about a perimeter 306 of the layer 302, or a protrusion 308 formed into a recess in the optical element. In general, the imaging cartridge 300 and/or layer 302 may have any of a variety of shapes. For example, the layer 302 may include a perimeter 306 in the shape of a circle, an ellipse, a square, a rectangle, or any other polygon or other shape.

A variety of imaging cartridges incorporating features described herein will now be described.

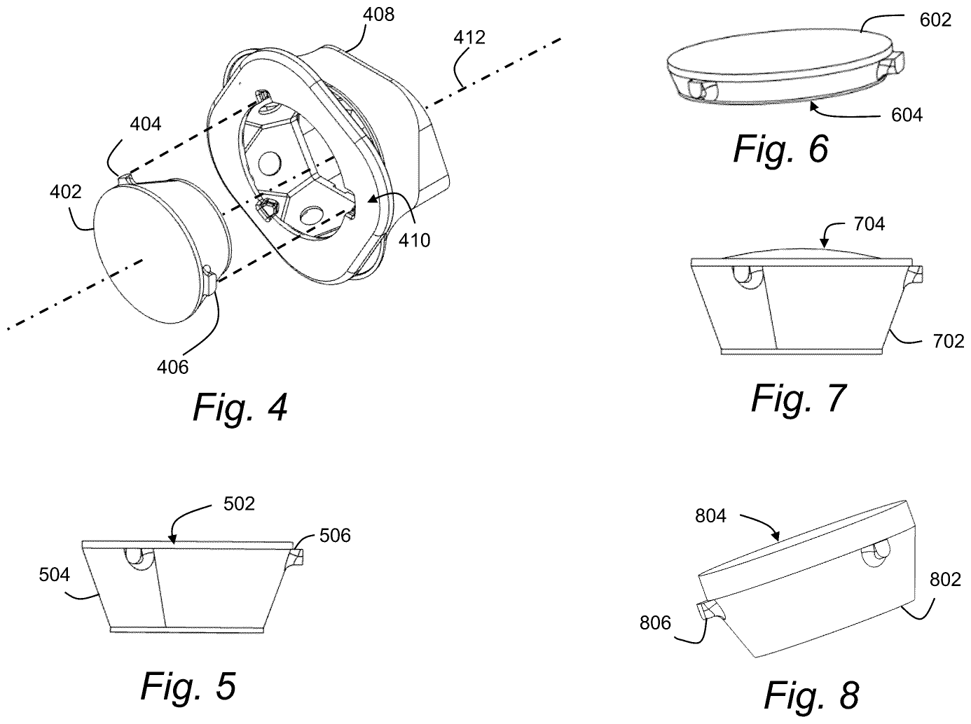

FIG. 4 is a perspective view of an imaging cartridge and a housing for an imaging system. The imaging cartridge 402 may for example, be any of the imaging cartridges described herein. In general, the imaging cartridge 402 may include a number of protrusions 404, 406, which may be axially asymmetric in order to enforce a unique radial orientation within the housing 408. For example, one protrusion 406 may be larger than the other protrusions 404 in order to provide radial keying, or the protrusions 406 may be irregularly spaced in a manner that enforces a unique radial orientation, or some combination of these. The housing 408 may include a number of slots 410 or the like to receive the protrusions 404, 406, after which the imaging cartridge 402 may be rotated about an axis 412 of the imaging system 400 so that the protrusions 404, 406 securely retain the imaging cartridge 402 within the housing 408. The protrusions 404, 406 may for example, form a kinematic coupling with the slots 410 of the housing 408 to enforce a predetermined geometric orientation of the imaging cartridge 402 within the housing 408 and an associated imaging system.

FIG. 5 is a side view of an imaging cartridge for an imaging system. It will be noted that, in the embodiment of FIG. 5, a top surface 502 of the imaging cartridge 504 extends above a number of protrusions 506 that are structurally configured to secure the imaging cartridge 504 to a housing. This may permit a layer of an elastomer to extend beyond the surface of the housing sufficiently so that the housing does not interfere with contact between the elastomeric layer and a target surface. As described above, a layer of transparent elastomer (not shown) may be affixed to the surface of the imaging cartridge 504 using any suitable techniques.

The imaging cartridge may have a variety of different shapes, and may usefully share a mounting interface such as protrusions so that different types of imaging cartridges can be used within the same housing for different imaging applications. FIG. 6 is a perspective view of an imaging cartridge 602 having a low profile. The imaging cartridge 602 may be shaped and sized to fit securely within a housing such as the housing 408 of FIG. 4, but may be thinner, e.g., to reduce optical aberrations in images captured through the imaging cartridge 602 or to facilitate the use of additional optical elements such as filters, imaging lenses, and the like between the imaging cartridge 602 and a camera or other imaging device of an imaging system. This profile can also or instead advantageously accommodate lighting through the surface 604 facing a camera (and opposing an elastomer layer and target surface) to facilitate illumination and imaging of high-aspect negative features on the target surface such as trenches, deep grooves, and the like. In this context, the term “high-aspect” is intended to refer to features that are (or might be) occluded from illumination at grazing illumination angles of, e.g., more than forty-five degrees from the surface normal.

FIG. 7 is a perspective view of an imaging cartridge. The imaging cartridge 702 may include a convex surface 704 shaped to support an elastomer layer in a manner that extends away from the imaging cartridge 702, which may advantageously permit imaging of relatively concave surfaces, and may also advantageously mitigate bubble formation when the elastomer layer is placed on a target surface for image capture. The imaging cartridge 702 may be shaped and sized to fit securely within a housing such as the housing 408 of FIG. 4.

FIG. 8 is a perspective view of an imaging cartridge. The imaging cartridge 802 may usefully incorporate a high-profile contact surface 804 that extends away from the protrusions 806 of the imaging cartridge 802, e.g., to provide greater clearance between a housing and the imaging surface. The imaging cartridge 802 may be shaped and sized to fit securely within a housing such as the housing 408 of FIG. 4. In general, the foregoing imaging cartridges may be used interchangeably with a single housing, thus facilitating different modes of operation supported by different imaging cartridge properties. Further, by providing a kinematic coupling or similarly orientation-specific mounting system, calibration results and the like for a particular imaging cartridge may be recalled and reused when a previously used imaging cartridge is once again placed within the housing.

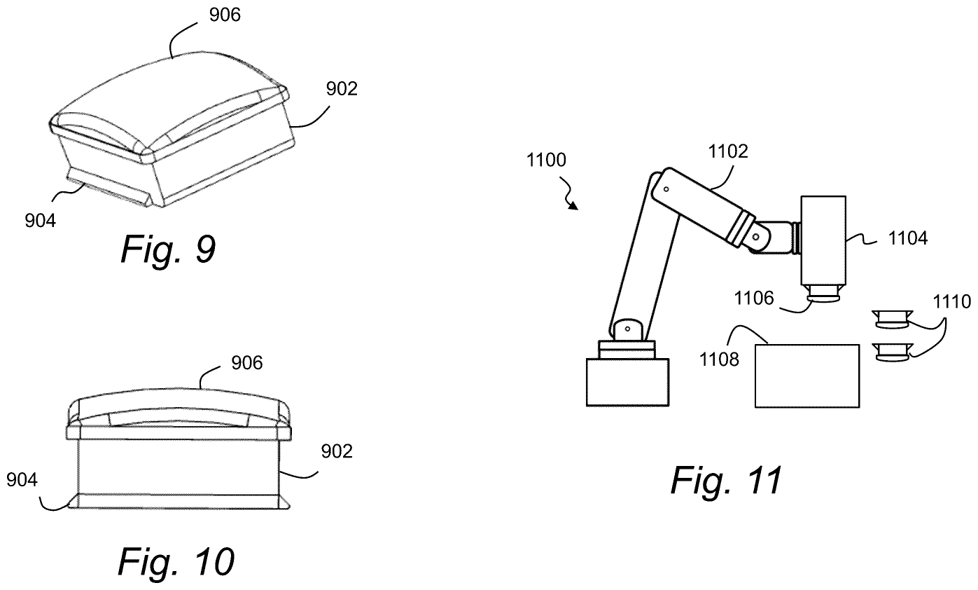

FIG. 9 is a perspective view of an imaging cartridge. The imaging element 902 may for example, have a generally rectangular construction, and may include one or more flanges 904 or the like so that the imaging element 902 can linearly slide into engagement with a fixture of a housing. This type of engagement mechanism may be particularly suited to robotic applications or the like, such as where the imaging element 902 is removed from and replaced to an end effector of a robotic arm. The imaging element 902 may for example, be any of the imaging cartridges described herein, with corresponding surface and sidewall properties. A layer 906, such as any of the layers of optically transparent elastomer described herein, may be disposed on the imaging element 902 to provide a contact surface for capturing topographical images of a target surface. The layer 906 may be convex, or otherwise curved away from the imaging element 902, e.g., to provide clearance from a housing and/or to mitigate formation of air bubbles when the layer 906 is placed for use on a target surface. FIG. 10 is a side view of the imaging cartridge of FIG. 9.

FIG. 11 shows a robotic system using an imaging cartridge. In general, the system 1100 may include a robotic arm 1102 coupled to a housing 1104 configured to removably and replaceably receive a cartridge 1106 such as any of the imaging cartridges or other optical devices described herein. The robotic arm 1102 (or any other suitable robotic element(s)) may be configured to position the cartridge 1106 in contact with a target surface 1108 in order to capture topographical images of the target surface 1108 through the cartridge 1106 using, e.g., a camera or other imaging device in the housing 1104. In general, the system 1100 may be configured to automatically remove the cartridge 1106 from a fixture of the imaging system 1100 (e.g., in the housing 1104), and to insert a second cartridge 1110 into the housing 1104. The second cartridge 1110 may be the same as the cartridge 1106, e.g., to provide a replacement after ordinary wear and tear, or the second cartridge 1110 may have a different optical configuration than the first cartridge 1106, e.g., to provide greater magnification, a larger field of view, better feature resolution, deep feature illumination, different aggregate surface shape, different shape tolerances for the target surface 1108, and so forth. The second cartridge 1110 may be stored in a bin or other receptacle accessible to the robotic arm 1102 of the system 1100. In general, the system 1100 may include one or more magnets, electromechanical latches, actuators, and so forth, within the housing 1104, or more generally within the system 1100, to facilitate removal and replacement of the cartridge 1106 as described herein. More generally, the system 1100 may include any gripper, clamp, or other electromechanical end effector or the like suitable for removing and replacing the cartridge 1106 and positioning the cartridge 1106 for use in an imaging process.

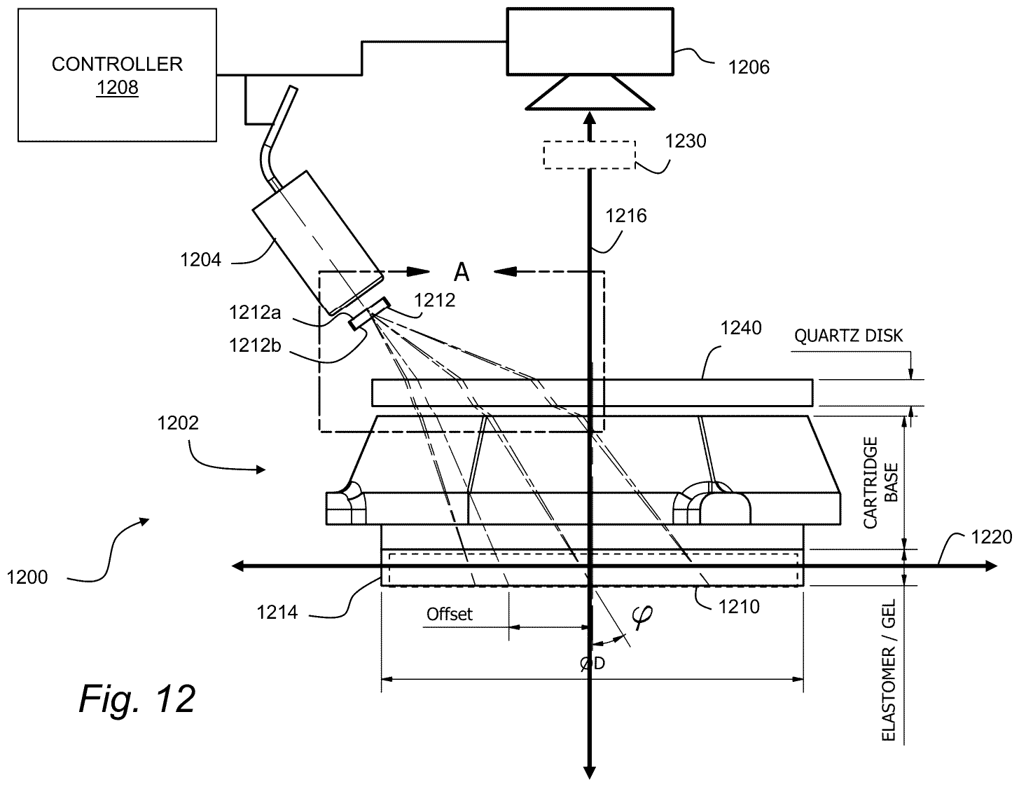

FIG. 12 shows an imaging system with an imaging cartridge. In general, the imaging system 1200 may include a cartridge 1202 including any of the retrographic sensors or other elastomeric or conformable optical sensors or the like described herein, with differences as described below. The imaging system 1200 may also include a light source 1204, an imaging device 1206, a controller 1208, and an imaging volume 1210. An optical element 1212 may be positioned to control illumination of the imaging volume 1210 by the light source 1204.

The cartridge 1202 may be removably and replaceably coupled to the imaging system 1200, and may be mechanically keyed or otherwise coupled to the imaging system 1200 in a manner that aligns a sensing region 1214 of the cartridge 1202 with the imaging volume 1210 of the imaging system 1200. The cartridge 1202 may, for example, include an elastomeric optical element having a soft, optically clear elastomer on a first side facing the imaging device 1206 and a thin, reflective coating on a second side opposing the imaging device 1206 and configured to deform when placed in contact with a target surface for measurement. More generally, the cartridge 1202 may include any of the retrographic sensors or other elastomeric or conformable optical elements described herein for contacting a target surface to facilitate three-dimensional imaging, with the cartridge 1202 structurally configured to position the sensor within the imaging volume 1210 when the cartridge 1202 is placed for use in the imaging system 1200. The imaging system 1200 may have an axis 1216, such as an imaging axis or an optical axis, that passes through the imaging volume 1210. When the cartridge 1202 is placed for use in the imaging system 1200, the sensing region 1214 of the cartridge 1200 may thus intersect the axis 1216 of the imaging system 1200 and lie within the imaging volume 1210 so that the imaging device 1200 can capture images of the sensing region 1214 of the cartridge 1202 within the imaging volume 1210 of the imaging system 1200.

The light source 1204 may be any illumination source suitable for providing illumination through the optical element 1212 and into the imaging volume 1210. When the cartridge 1202 is placed for use in the imaging system 1200, the light source 1204 may illuminate the sensing region 1214 of the cartridge 1202 and permit capture of images by the imaging device 1206. These images may in turn, be processed by the controller 1208 to resolve three dimensional surface information for an object contacting the sensing region 1214 of the cartridge 1202. In one aspect, the light source 1204 may be a laser or other device that has a coherent, fixed focus and/or that provides collimated illumination. In this context, it will be understood that the fixed focus may include light focused at infinity, i.e., light that is collimated or formed of parallel ray traces, as well as light with any other fixed focus that can be used to create the illumination patterns described herein. In another aspect, the light source 1204 may provide unfocused illumination, with suitable modifications to the optical element 1212 and other optical features.

The imaging device 1206, may be a camera or any other combination of optical devices, lenses, filters, and other hardware suitable for capturing images of the imaging volume 1210 for use by the controller 1208 in resolving three-dimensional images. In general, the imaging device 1206 may have an imaging axis, such as the axis 1216 of the imaging system 1200, passing through the imaging volume 1210 in order to capture images thereof.

The controller 1208 may include any processor, microcontroller, or other circuitry, or combination of the foregoing, suitable for controlling operation of the imaging system 1200 to acquire three-dimensional information as described herein. In one aspect, the controller 1208 physically coupled to the imaging system 1200 may provide limited control of data acquisition, e.g., to acquire data for transmission to a separate processor for processing. In another aspect, the controller 1208 may include one or more microprocessors, field programmable gate arrays, graphics processing units, and/or other processors to process images and resolve image data into three-dimensional data for a surface within the imaging volume 1210. In one aspect, the controller 1208 may include a processor configured by instructions stored in a memory to receive an image from the imaging device 1206 of light from the pattern created by the optical element 1202 and reflected by the thin, reflective coating of an elastomeric optical element or other sensing region 1214 as it deforms to a surface of an object within the imaging volume 1210. This processor, or another processor integrated into the imaging system 1200 or communicatively coupled to the imaging system 1200 may be further configured by instructions stored in a memory to calculate a quantitative surface topography of the surface based on the image captured by the imaging device 1206. As described herein, the surface may include, e.g., a deformable surface of an elastomeric optical element intersecting the imaging volume 1210 and configured to conform to a target surface of an object to be measured. As the target surface intersects the imaging volume 1210, an image of the deformable surface captured by the imaging device 1206 may be used to infer the three-dimensional shape of the target surface.

The imaging volume 1210 may generally define a three-dimensional field of view for the imaging device 1206. As described above, the imaging device 1206 may have an imaging axis, such as the axis 1216 of the imaging system 1200, that passes through the imaging volume 1210. A plane may intersect the imaging volume 1210 and lie substantially perpendicular to the imaging axis of the imaging device 1206. This plane also lies substantially perpendicular to the plane of FIG. 12, and is illustrated as a line 1220 where the plane intersects FIG. 12 and the imaging volume 1210 depicted therein.

The optical element 1212 may include any optical elements including diffraction gratings, lenses, filters, microtextured surfaces, metasurfaces, and the like, suitable for creating a desired illumination pattern within the imaging volume 1210. In general, the pattern may include a plurality of features such as dots, lines, polygons, or the like that can be identified within an image of the imaging volume 1210 captured by the imaging device 1206. For example, the pattern may usefully include a first plurality of features closely spaced within the plane and a second plurality of features visually distinguishable from the first plurality of features and more distantly spaced within the plane. In this pattern, the more distantly spaced features may provide fiducials or landmarks within the imaging volume 1210 to assist in processing, while the more closely spaced features support higher-resolution sensitivity to surface topography. The pattern may also or instead include a first plurality of features and a second plurality of features collectively forming a regular geometric pattern within the plane, with the second plurality of features forming visually distinguishable anchor points within the pattern. The anchor points or landmarks may be spaced sufficiently far apart so that they are unlikely to intersect (or physically unable to intersect) within the imaging plane due to deflection along the axis 1216. In these embodiments, the pattern may generally include a first plurality of features closely spaced to provide high resolution detection of depth within the imaging volume and a second plurality of features placed sufficiently far apart within the plane through the imaging volume 1210 to avoid intersections along the imaging axis (e.g., axis 1216) within the imaging volume 1210 during a maximum expected deformation of a contact surface of an elastomeric optical element, retrographic sensor or the like within the imaging volume 1210. It will be understood that in this context, the expected deformation may include z-axis displacement, as well as any x-axis or y-axis displacement resulting from sheering, wrinkling, and the like of the elastomeric optical element as the imaging system 1200 is placed against a target surface and manipulated by a user.

In one aspect, the optical element 1212 may include a diffractive optical element positioned to receive the illumination from the light source 1204 (e.g., a coherent light source such as a laser) on a first surface 1212a (e.g., a surface facing the light source 1204) and create a three-dimensional illumination pattern within the imaging volume 1210 from a second surface 1212b opposing the first surface 1212a. Where a diffractive optical element is used, the diffractive optical element may include micropatterned structures, e.g., on either or both of the surfaces 1212a, 1212b, optionally along with additional lenses, that cooperate to create the desired illumination pattern when a suitable light source is directed toward the first surface 1212a. A variety of types of diffractive optical elements are known in the art, and may be used to create illumination patterns that vary in intensity in a far-field plane, and that vary in intensity and/or focus along an imaging axis. As a significant advantage, these properties may be exploited to create a three-dimensional illumination pattern within the imaging volume 1210 of an imaging system 1200 to facilitate resolution of three-dimensional information from a surface on the sensing region 1214 of the cartridge 1202. More specifically, a diffractive optical element may be used to create illumination patterns with complex three-dimensional structures, e.g., that are not simple two-dimensional projections that scale linearly with distance. These patterns can usefully encode distance within an imaging volume in a manner that can facilitate shape recovery from single images. Any number of additional optical components may also or instead be included to create illumination patterns as described herein. For example, interfaces between layers or components of the optical system may incorporate light shaping features such as lenses, filters, and the like, e.g., to control optical power, compensate for distortions or wavefront errors, and so forth.

Furthermore, while suitable Diffractive Optical Elements (DOEs) may be configured, e.g., with micro-patterned and/or nano-patterned structures on various optical surfaces of a discrete optical element as illustrated in FIG. 12, the DOE may also or instead be implemented in other physical locations within the optical path for illumination, e.g., with micro-patterning of the sidewall, top, and/or bottom of the cartridge substrate, and/or within other optical elements of the system.

In this context, a three-dimensional illumination pattern may include any three-dimensional shape, pattern, or structure that varies with depth or distance from the optical element 1212. For example, a three-dimensional illumination pattern may include diverging illumination projections such as a grid, point array, cone, or pyramid pattern that diverges (e.g., becomes larger in an imaging plane) as distance from the optical element 1212 increases, or more generally, a three-dimensional pattern varying along the imaging axis (e.g., the axis 1216) within the imaging volume 1210. In another aspect, the three-dimensional illumination pattern may include a pattern with one or more features that vary along a line of projection from the optical element 1212. For example, a circle, dot, or other image may change in intensity or focus (with or without a change in size) as a distance of the projected image from the optical element 1212 increase. These geometric characteristics of the three-dimensional illumination pattern may usefully be created by a diffractive optical element and used to improve accuracy of three-dimensional data based on images of the sensing region 1214 captured by the imaging device 1206.

In one aspect, the optical element 1212 may be positioned to create a pattern within the imaging volume 1210 from a surface at an oblique angle to the plane intersecting the imaging volume 1210, such as an angle of at least thirty degrees, at least forty-five degrees, at least sixty degrees, about sixty degrees, or between fifty and seventy degrees. It will be understood that ray traces from the optical element 1212 may change angles multiple times as the light from the optical element 1212 is optically coupled to the sensing region 1214. For example, the light may travel through surfaces of a quartz sheet 1240 such as a quartz disk or the like used to protect/seal an interior of the imaging system 1200 from the exterior environment where the cartridge 1202 is removably coupled to a body of the cartridge 1202. In this context, unless stated otherwise, the angle of interest is the angle at which these ray traces intersect the plane (identified by the line 1220) through the sensing region 1214, which is where the illumination meets the deformable surface of the cartridge 1200 and image data is captured for resolving three-dimensional shape.

It will be appreciated that while a plane intersecting the imaging volume 1210 provides a useful frame of reference for discussing other features and structures of the imaging system, in one aspect, the imaging volume 1210 may be bounded by curved surfaces, e.g., where the retrographic sensor is pre-shaped for measuring spherical, cylindrical, or other concave or convex surfaces, or more generally, any other target surfaces having a characteristic shape that is known. In such cases, a single plane may omit significant extents of the imaging volume 1210. A plane of interest may nonetheless be selected, such as a plane normal to an optical axis of an imaging device used to capture images of the imaging volume 1210, or a plane normal to an axis of a lens used to focus an image from the imaging volume 1210, or a plane tangent to a contact region of the target surface, or a plane otherwise oriented to provide a frame of reference for describing angles of illumination, imaging, contact, and so forth.

In many illumination patterns, steeper incident angles (e.g., more acute angles relative to the plane) can provide greater sensitivity to three-dimensional displacement. As such, where side illumination is provided as depicted in FIG. 12, it may be advantageous to include one or more additional light sources 1204 and/or optical elements 1212 to provide illumination from different directions around the axis 1216 of the imaging device 1200 so that different regions of the imaging volume 1210 can benefit from steep side illumination. In one aspect, these additional light sources 1204 may also use different spectral bands so that different patterns can be captured simultaneously, e.g., in a single image frame, where visual features can be associated with specific light sources 1204 and DOEs (or other optical elements) in based on wavelength. This approach can also advantageously improve sensing of occluded areas and/or steep or sharp surface features of a surface. Thus, in one aspect, three-dimensional data for different portions of the sensing region 1214 may be calculated using illumination from different light sources and/or optical elements. While the images captured by the imaging device 1206 in such embodiments may be divided and processed strictly in this manner (e.g., with one side of the imaging volume 1210 processed using illumination from an opposing side of the imaging volume 1210), the image data from different illumination directions may also or instead be combined or weighted in a number of manners where such combinations can be demonstrated to improve accuracy or repeatability for a particular imaging system, or where such combinations permit analysis of occlude regions, deep valleys, and the like.

In another aspect, different illumination sources may be multiplexed, e.g., by using light of different wavelength ranges (or different specific wavelengths) to illuminate the imaging volume 1210 from different directions, and by separately processing the images from these different wavelength ranges so that multiple images from multiple illumination directions can be concurrently captured and/or processed. According to the foregoing, the imaging system 1200 may usefully include a second diffractive optical element positioned and structured to create a second pattern within the imaging volume 1210 for a different location about a perimeter of the imaging volume than the first diffractive optical element. More generally, two or more additional light sources and/or optical elements may be incorporated into the imaging system 1200 to improve imaging under various imaging conditions with various surface topographies.

In another aspect, additional imaging techniques may be incorporated into the imaging system 1200, e.g., to improve accuracy and robustness of the imaging system 1200, to support higher-speed, lower-resolution processing for certain imaging contexts (image previews, sparse three-dimensional processing, etc.), or for other reasons. Thus, in one aspect, the imaging system 1200 may include a multi-view imaging system (e.g., a stereoscopic imaging system, photometric stereo system, or the like) configured to calculate a quantitative surface topography of a surface within the imaging volume 1210 based on images of the surface from two or more different perspectives. In this context, a multi-view imaging system may include a stereoscopic imaging system, a photometric stereo system, or the like, and/or imaging systems that are multiplexed using fluorescence, different visible and/or infrared wavelengths, and so forth. In another aspect, a gradient-based system may use unfocused illumination from various directions to resolve three-dimensional surface information. In general, these alternative imaging modalities may be optically multiplexed for concurrent operation with the system described above. For example, these alternative systems may resolve a three-dimensional shape of the surface using light from a second light source in a second spectral band having wavelengths non-overlapping with a first spectral band of the light source 1204 and/or one or more other light sources used by the imaging system 1200. The imaging system 1200 may also or instead employ confocal three-dimensional imaging to reject out-of-focus light and incrementally capture images at two-dimensional slices passing through the imaging volume. These individual slices of an in-focus surface can then be combined into a three-dimensional reconstruction.

More generally, any of a variety of complementary imaging modes may be used to measure absolute depth with greater accuracy, such as multi-view three dimensional imaging based on stereo parallax, or a system with an optical pattern that translates depth directly into X-Y displacement, or any other triangulation-based or other depth measurement technology. As a significant advantage, these complementary techniques for measuring absolute depth, support improved measurement of low spatial frequency three-dimensional features such as macroscopic, large-scale features of a target surface that are preferable removed before measuring micron scale surface features with gradient-based depth calculations or the like. Furthermore, these depth measurements can provide information on the amount of elastomer compression within an imaging gel, provide real-time guidance and user feedback for optimal compression, support higher-speed rendering (e.g., using a sparser data array), support measurements of high frequency force (e.g., using a finite element model of the elastomer), and so forth.

In one aspect, there is disclosed herein an imaging system such as any of the imaging systems described herein, the imaging system 1200 including a supplemental depth measurement mode used to measure a distance to a target surface, estimate a compression of an elastomeric imaging medium such as any of the elastomeric optical elements described herein, and provide feedback to a user guiding the user to an optimal range of contact forces. This may for example, include user feedback via a number of LEDs or the like on a handheld imaging device such as that described herein, an auditory output device, or a display in a user interface for the device, e.g., on a computer or the like coupled to the handheld device.

In one aspect, the imaging system 1200 may include a lens 1230 for variably focusing the imaging device 1206 on a surface within the imaging volume 1210, such as a reflective surface of a retrographic sensor or other device including an elastomeric optical element or the like. For example, the lens 1230 may be a liquid lens that uses a combination of optical fluids and a polymer membrane to change focus by changing shape, or any other adaptive lens or the like. A liquid lens advantageously provides a compact mechanism for controlling focus without mechanical, moving parts and without physically moving a lens along the imaging axis to change focusing distance. However, other lenses may also or instead be used to focus of the imaging device 1206 at various depths or z-axis positions through the imaging volume 1210 and along the imaging axis, and may be adapted for use in an imaging system 1200 as described herein, such as a lens system focused with a piezo-focus drive, a voice coil motor, or any other electromechanically controlled lens or lens system suitable for z-stack image acquisition.

As a significant advantage, this supports the use of high-resolution lenses with narrow depth-of-field. In order to avoid low-pass filtering that might otherwise be imposed by a locally out-of-focus lens, lens 1230 can be variably focused to scan through a range of depths (e.g., along the z-axis or imaging axis) to provide partial, locally focused images at each desired depth. This stack of images can be assembled into a single image with greater depth-of-field for subsequent three-dimensional processing, e.g., with photometric stereo, or to directly measure quantitative depth information by finding the best focus among various focal depths for local regions within the imaged field. This single image with improved depth-of-field also permits recovery of texture or the like, and may be combined with other imaging modalities (such as photometric stereo) to provide more accurate and high resolution surface measurements across an imaged field without distortion artifacts.

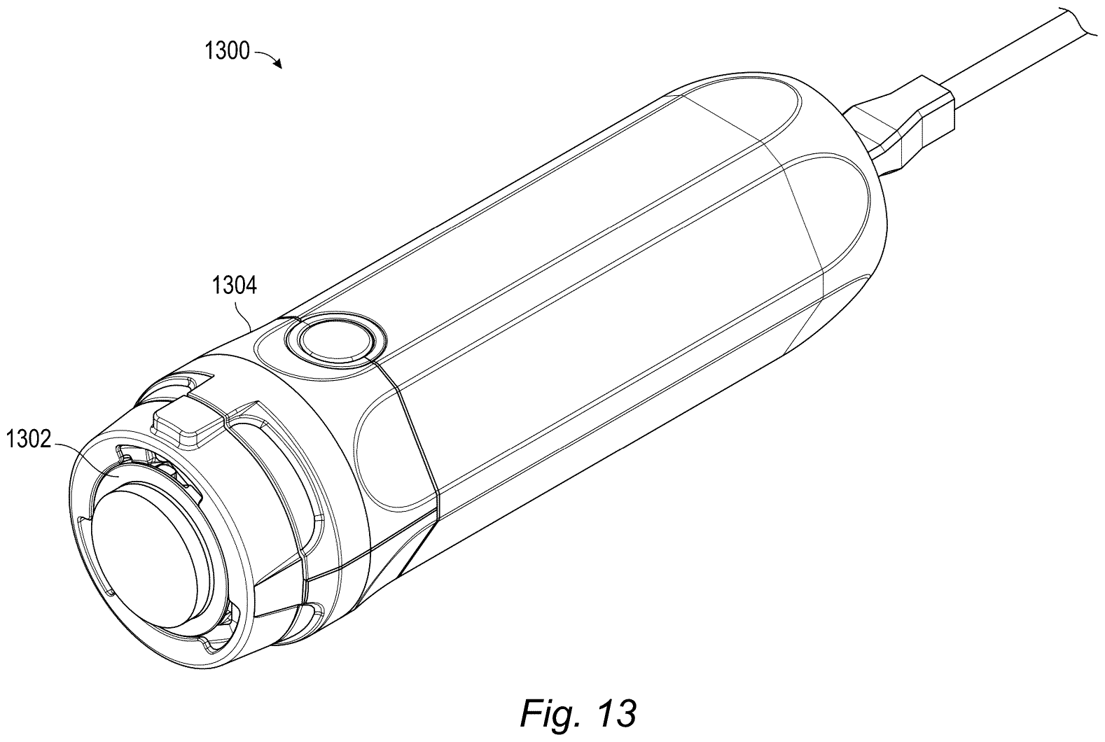

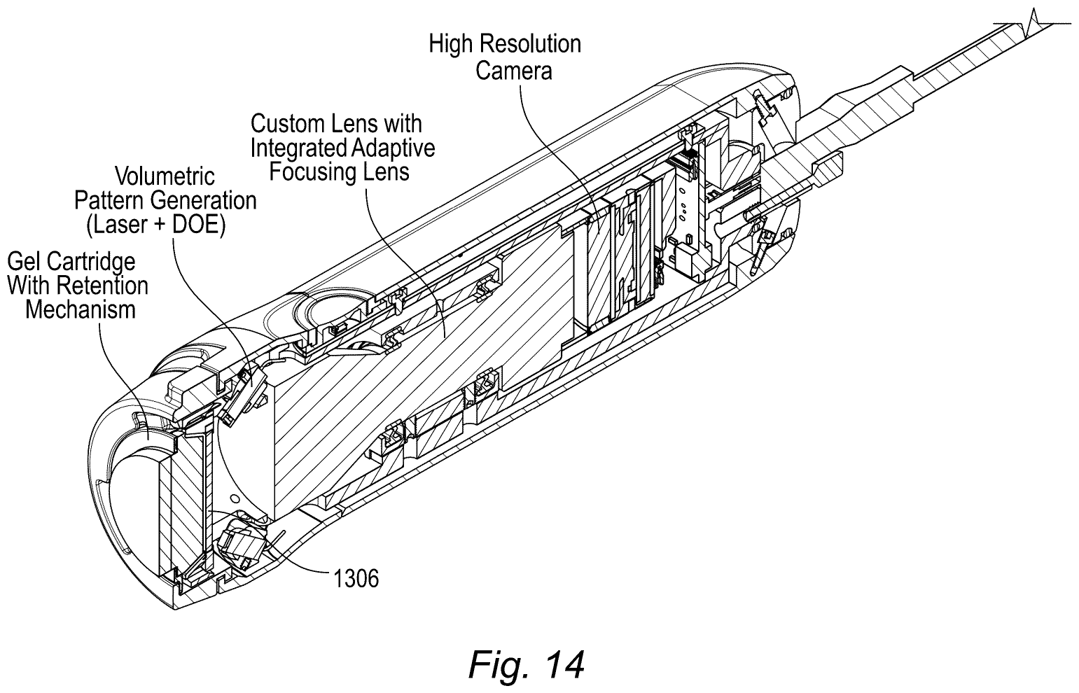

Other aspects of a modular retrographic sensing system are now described by way of non-limiting example embodiments. FIG. 13 shows an imaging system 1300 with a retrographic sensing cartridge 1302 that can be removed from and replaced to a housing 1304 of the imaging system 1300. FIG. 14 shows a cut away view of the imaging system.

In one aspect, the system may use photometric stereo imaging to measure surface orientation, e.g., as surface normal vectors based on pixel intensity, which can be integrated to resolve three-dimensional surface data. While this reconstruction approach can be sensitive to small changes in surface orientation that cause low frequency distortion, resulting in small scale distortions across the measured field. Thus, the system may supplement photometric stereo imaging with triangulation-based 3D reconstruction, which advantageously permits direct depth measurements at each location to provide distortion free 3D measurements at lower resolution.

This combined approach advantageously supports high resolution 3D measurements with consistent resolution and accuracy across the entire imaging field.

As described above, a pattern projection system for the device may create a dot pattern projected at a highly oblique angle to the target surface. Suitable patterns may be created using laser illumination of a Diffractive Optical Element (DOE), which may be micro-patterned to suppress and amplify specific diffractive orders (using the coherence of the laser) to create an optical pattern with the desired locations for dots or other objects, shapes, symbols, etc. The DOE may also or instead be configured (e.g., by micro-patterning the surface(s) thereof) to adjust for a varying focus across the imaging volume due to the highly oblique projection angle relative to an imaging plane within the imaging volume. In general, the projected pattern may be imaged by the imaging device to provide triangulation for 3D imaging. As an object for measurement is pressed into the contact surface of the retrographic sensor, the dot pattern is warped in the imaging volume according to the local depth change. The motion of the dots thus encodes the 3D shape of the object in a manner that can be captured and resolved into 3D data with the imaging device and processor.

The foregoing design incorporates a number of features that may advantageously permit pattern generation and three-dimensional data resolution in a small device with a short optical axis. For example, while dot projection based 3D reconstruction methods are known, the disclosed device can advantageously use large DOE exit angles to support dot pattern generation in steep side illumination within a short distance. In one aspect, the optical system uses a laser focused on the target (e.g., on a point within the imaging volume or on an imaging plane therein), with the DOE configured to adjust focus laterally across the imaging volume. To implement such a system, the laser may include a focusing lens or system that focuses on the target while taking account of the full optical chain from the laser to the target surface. In another aspect, the system uses a highly oblique projection.

In one aspect, the housing 1304 for the system contains the imaging device, illumination system, and other related optical and electrical components inside an internal chamber to isolate these components from an external environment. For example, the housing may include a quartz disk 1306 or other optically clear region where the cartridge of the modular retrographic sensor couples to the housing for use. However, due to variations in the indices of refraction through these various optical components of the optical chain from the laser to the sensing region, which may include the diffractive optical element, a quartz disk 1306 for the housing, a polymer such as polymethyl methacrylate (PMMA) forming a rigid, optically clear substrate for the modular sensor, and an elastomeric gel of the sensing region that is coupled to the clear substrate, the exit angles for the DOE in some aspects will be even more oblique than the beam angles within the sensing region of the cartridge. Thus, the already large exit angles required by the desired side illumination may become even greater for a cartridge-based system such as that disclosed in FIGS. 13-14.

According to the foregoing, an imaging system may more generally use any suitable combination of different three-dimensional imaging modalities within a retrographic sensor or other device having an elastomeric imaging medium. For example, in one aspect, there is disclosed herein a device including an imaging volume within a conformable imaging medium, such as any of the elastomers or other conformable, optically clear materials described herein, the imaging volume defining a three-dimensional field of view for capturing images, along with an imaging system configured to calculate a quantitative surface topography of a target surface intersecting the imaging volume (and displacing the conformable medium) within the three-dimensional field using two or more three-dimensional imaging modalities including at least photometric stereo and multi-view stereo imaging.

In general, photometric stereo may use a single camera, with directional lighting provided from two or more directions. Depth is encoded in shading variation between the captured images (e.g., intensity gradient). This modality supports spectral multiplexing, e.g., with red-green-blue (RGB) or hyperspectral imaging to capture an image with multiple illumination directions in a single image frame.

The concurrent, multi-view stereo imaging modality may use any of a variety of techniques to obtain depth information from multiple cameras or views. In another aspect, single camera triangulation may be used. In this modality, the imaging volume is illuminated with structured light from one or more directions (different than the viewing direction for the camera), and depth is determined based on an imaged pattern relative to a reference image of the structured light captured during calibration. Where multiple light directions are used for illumination, these must be sequentially or spectrally multiplexed to avoid visual interference among overlapping illumination patterns. In another aspect, multi-view stereo or triangulation may be used to obtain depth information from two or more cameras under structured illumination. In another aspect, multi-view stereo or triangulation may be used to obtain depth information from two or more cameras based on surface texture.

In another aspect, one of the imaging modalities may include focus stacking where focus/defocus along an optical axis through the imaging volume is used to infer depth. This may be used instead of or in addition to the multi-view stereo techniques described above. A focus stacking system may use uniform natural light, provided the target surface contains sufficient natural texture to evaluate focus. In another aspect, structured light (typically coaxial with optical axis) may be used, particularly where the target surface does not provide suitable features for evaluating focus. In either case, different colors can be focused at different depths in order to support increased depth resolution using spectral multiplexing.

In one example embodiment, the imaging system may use photometric stereo and multi-view stereo with an artificially textured membrane or the like on the contact surface of the elastomeric optical element. Specifically, the texture may be a random texture that is invisible unless specific illumination is used. For example, the random texture may be created using fluorescent pigments, which are visible only when illuminated by UV light. Alternatively, the membrane may use IR absorbing pigments to create the random texture that requires IR illumination to make the texture visible. In this combination the random texture is imaged only by the cameras dedicated to multi-view stereo, while the photometric stereo camera (single camera) views the field in the imaging volume without the texture using illuminations in a different spectral band having different illumination directions. It will be understood that other arrangements of photometric stereo and the various multi-view imaging techniques described above may also or instead be used.

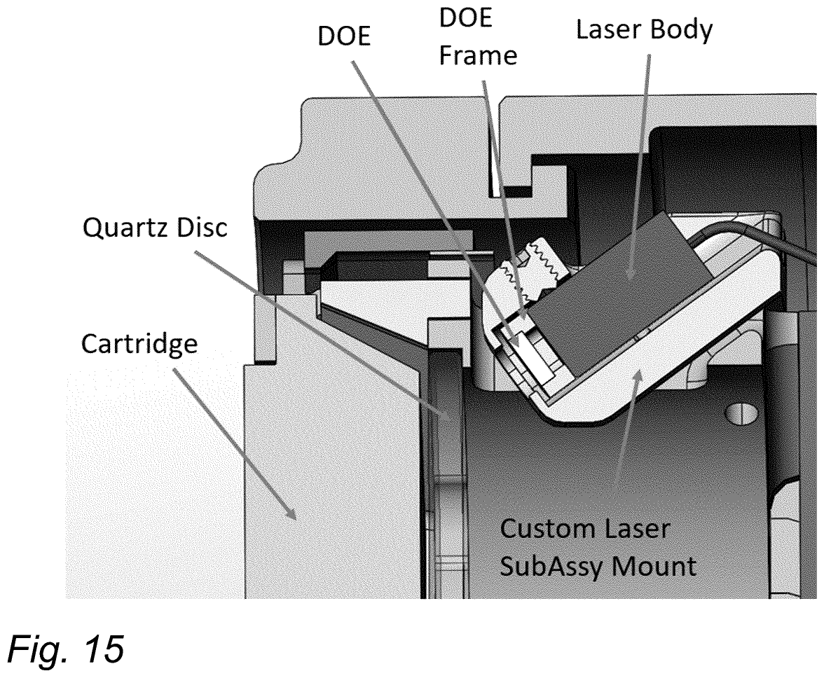

FIG. 15 shows a cross section of a DOE angled to the imaging axis of an imaging system. DOE exit angles may usefully be balanced for improved accuracy. In general, the DOE Exit Angles corresponding to the corners of the pattern are preferably as close to each other as possible. In one aspect, this can be achieved by tilting the DOE relative to the image axis in order to place the zero-order dot in the illumination pattern away from the center of the imaging volume and/or imaging plane, which advantageously provides more uniform illumination angles across the sensing region of the imaging system. The DOE may also or instead be designed using known techniques to adjust focus across the projected dot pattern within the imaging volume, which may be based on a laser beam focused on the zero-order spot within the pattern.

It will be understood that, in general, the DOE may be integrated into a removable cartridge, e.g., as a part of the rigid cartridge substrate, or the DOE can be a separate component coupled to the imaging system into which the cartridge is placed. When the DOE is included in the cartridge, the DOE may be formed of a micro-texture etched into the sidewalls of the cartridge, or the top/bottom of the cartridge substrate. This micro-texture can then be illuminated by a laser beam (in the imaging system) that can be collimated or focused according to the structure of the DOE to achieve a desired illumination pattern within the imaging volume. As an advantage, a DOE within the cartridge may minimize aberrations due to the oblique creation of the pattern because the incident light, however focused, falls directly on the homogeneous media (e.g., rigid cartridge +gel). If the illumination source has to pass through multiple interfaces for different materials (e.g., protective glass, rigid cartridge, gel, air) at an oblique angle then optical wavefront aberrations at each interface may introduce additional pattern artifacts.

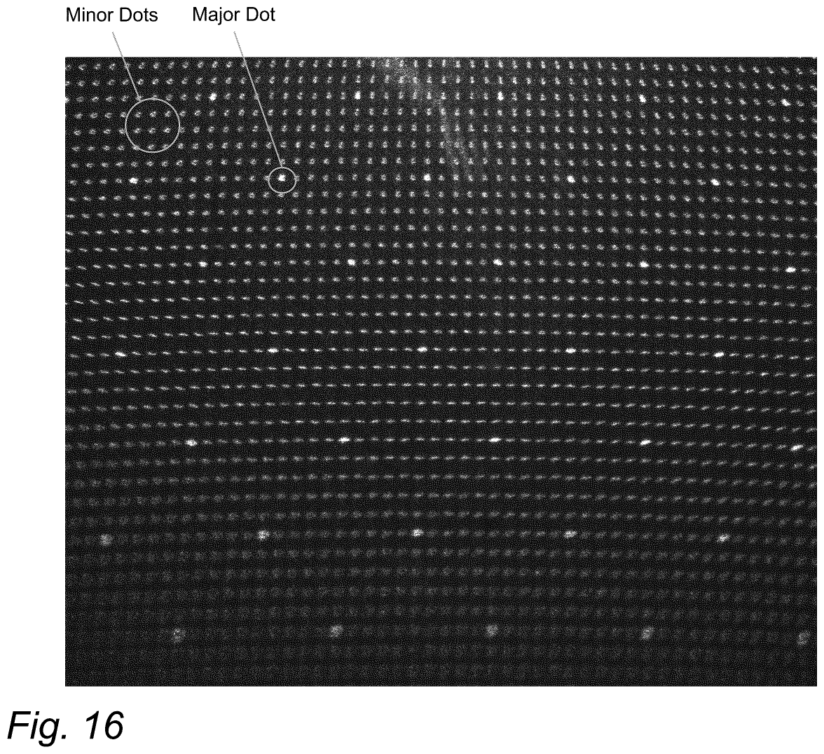

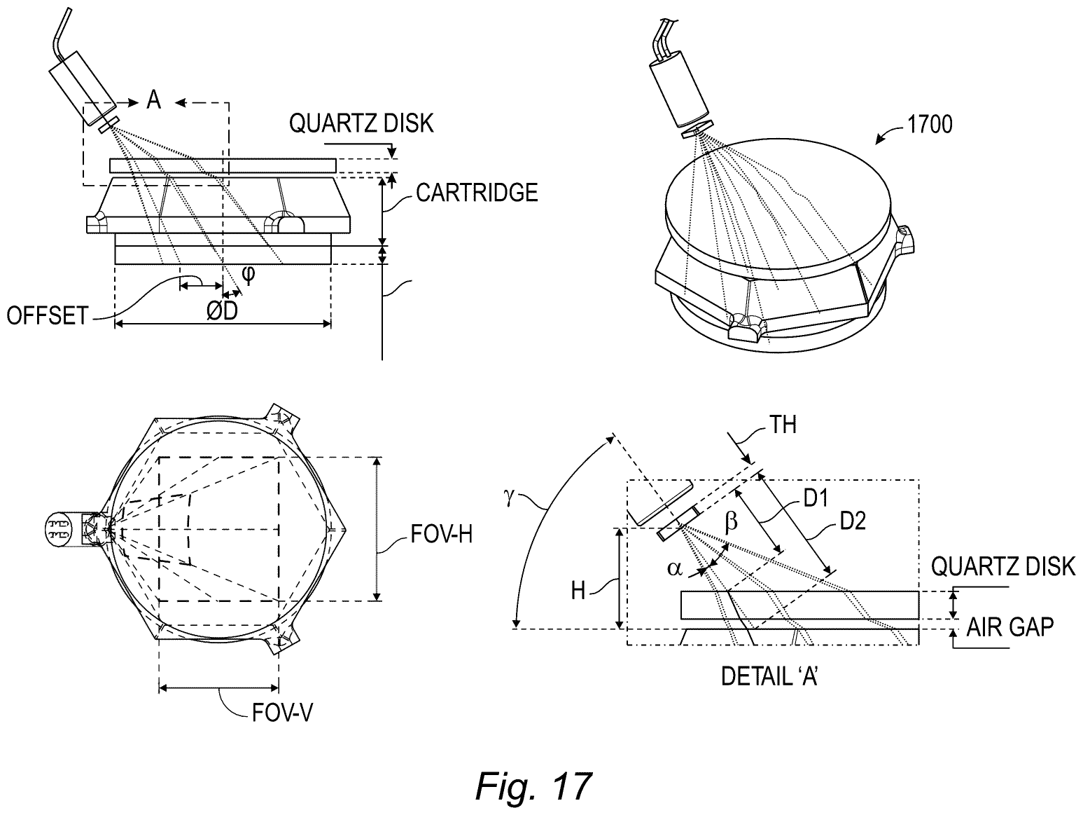

FIG. 16 shows an illumination pattern that can be created by the illumination systems described herein.

In one aspect, because of the fixed oblique projection angle described above, certain measured geometries may lead to occlusions. Additionally, the projection angle may change across the imaging volume creating non-uniform depth sensitivity. To compensate for this unfavorable condition, multiple pattern generation systems may work sequentially if they have the same wavelength or in parallel if they have different wavelengths. These systems may be positioned around the axis of the system as described above.

In another aspect, dots or other markings may be created with varying intensity. A regular dot pattern with the dots having the same intensity is less favorable because the dots cannot be easily distinguished from each other. As a significant advantage, an illumination system may create some dots with higher intensity to serve as anchors to allow tracking the pattern easier. Additionally, these higher intensity dots can be created with larger diameters to support multi-resolution processing schemes. In one aspect, the illumination system may thus create major dots and minor dots, however, other shapes and/or additional tiers of size may be created for additional resolution levels. Additionally, these dots may have different shapes or smaller scale intensity patterns to allow easier tracking.

In another aspect, the imaging system may be configured for concurrent imaging using triangulation based on the patterns from the diffractive optical element and photometric stereo imaging using directional side illumination. In general, the images used for Photometric Stereo cannot contain the dot pattern used for triangulation based 3D reconstruction. Thus, these images must be captured sequentially if the same spectral band is used for both. In another aspect, the system may be optically multiplexed to support concurrent capture of both images. For example, the system may provide side lighting in the red spectrum and a DOE pattern in the blue spectrum. An imaging device with RGB (red, green, blue) or CYM (cyan, yellow, magenta) sensitivity can then spectrally multiplex these images to concurrently capture the shading image in a red channel and a DOE pattern in a blue channel. This approach advantageously allows temporal synchronization of the 3D data based on shading and triangulation.

In another aspect, air bubbles or other optical interferers may be attached to an optical interface such as the interface of the solid substrate to the clear elastomer, in order to project a pattern of dots onto the contact surface of the sensing region under directional illumination.

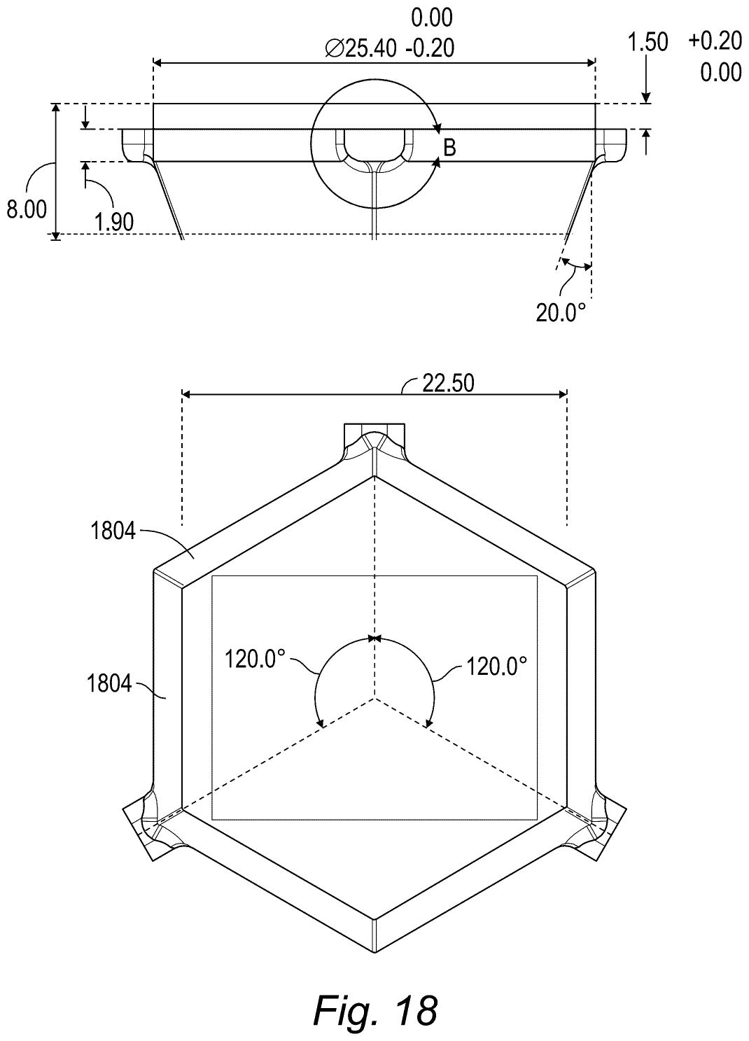

FIGS. 17 shows a cartridge for use in the systems and methods described herein. FIG. 18 shows a substrate for a cartridge for use in an imaging system. It will be understood that the dimensions shown in FIG. 18, or in any of the figures herein, are presented by way of example only and that other dimensions are also or instead possible unless expressly stated to the contrary. In general, the substrate may be formed of a rigid, optically clear material such as a clear polymer, a glass, or any other clear and mechanically rigid material suitable for coupling to a housing and supporting a retrographic sensor for use in imaging. In one aspect, the cartridge 1700 may have a hexagonal design, and may include one or more light emitting diodes, or any other suitable illumination sources, for side lighting along the side faces 1804 of the hexagonal design as described above (e.g., in FIG. 1), that may be used to support photometric stereo imaging concurrently with triangulation-based 3D reconstruction using the illumination pattern from the diffractive optical element.

The side faces 1804 of the cartridge 1700 may have a number of optical coatings or other treatments to improve performance of the imaging system. For example, the side faces 1804 may advantageously include an optical coating to reduce stray light. In some configurations, light can reflect back into the substrate of the cartridge 1700, e.g., from the outside surfaces of the cartridge. This may for example, be due to a scattering side surface (e.g., diffuser) on an outside of the cartridge 1700 or due to Total Internal Reflection (TIR) that creates light rays reflecting back into the cartridge 1700 from the outside surfaces of the cartridge 1700, either of which may create unwanted illumination that interferes with the desired illumination patterns used for three-dimensional reconstruction. To reduce stray light under these conditions, the side faces 1804 and any other side surfaces (and/or other surfaces other than the top and bottom of the cartridge 1700) may be coated with a Neutral Density (ND) filter. This ND filter layer may have the same refractive index as the material forming the optically clear substrate of the cartridge 1700 (e.g., PMMA) so that light will travel through the ND filter twice before it can reflect back into the cartridge volume. For example, if the ND filter has 50% transmission, the intensity of the stray light reflecting back into the imaging volume is reduced by (0.5*0.5=) 25% relative to light reflected back from the side surfaces without an ND filter.

In another aspect, a diffuser may be added to the side faces 1804 of the cartridge 1700 so that light from the light emitting diodes (or other illumination sources for side lighting) is more uniformly distributed to the target surface of the sensing region of the cartridge 1700. In general, light rays entering into the cartridge from external sources can miss illuminating the imaged area, e.g., the reflective surface of the sensing region of the cartridge 1700. Furthermore, given the proximity of the light emitting diodes to the surfaces of the cartridge 1700, the LEDs may produce high spatial frequency variations in illumination intensity within the imaging volume. To address these issues, a diffuser may be added to the side surface 1804 that receive the LED illumination, which may generally spread and spatially low pass filter incident illumination to provide more uniform illumination of the target surface.

In another aspect, the sides may be angled to the imaging axis to improve side illumination. In general, a vertical side to the cartridge allows two modes of direct illumination. The first mode travels through the side and then continues towards the sensing region, and ultimately illuminates the target surface. The second mode travels up towards the top of the cartridge where it internally reflects back toward the sensing region. This second mode increases the total illumination of the target surface. However, the combination of these two modes can create artifacts in a three-dimensional reconstruction, e.g., by altering the intensity of side illumination and the resulting surface normal estimations used for photometric stereo reconstruction. Thus, the sides may advantageously be angled toward the target surface to reduce reflected light from side illumination.

In another aspect, light emitting diodes for side illumination through the side surfaces may be arranged in lines along each side surface. Because individual diodes provide approximately point sources of light, they can create small, intense illumination regions within the imaging volume. Furthermore, while a single point light source creates illumination that attenuates in proportion to the square of the distance, a line or array of LEDs can create illumination that attenuates in proportion to the distance. Thus, a line of LEDs along one of the side surfaces of the cartridge advantageously creates a more uniform illumination field perpendicular to the direction of illumination and greater intensity over distance.

In another aspect, antireflective coatings may usefully be applied on various surfaces of the cartridge. For example, a top surface of the cartridge, the surface closest to the imaging device and generally perpendicular to the imaging axis, may be coated with an antireflective coating or other surface treatment in order to improve pattern projection from the DOE arriving at the top surface at an oblique angle. The top of the elastomeric material of the sensing region may also or instead receive an antireflective coating to similarly encourage propagation of the pattern projection through the cartridge and into the imaging volume, although this may be unnecessary where the refractive index of the rigid substrate is close to the refractive index of the elastomeric material.

In another aspect, the cartridge may include an identifier optically encoded into the cartridge. This may be a human-readable identifier such as a serial number laser marked into a surface of the cartridge, or a bar code, QRC code, or other pattern or the like encoding identifying information in a machine readable form. While other self-identifying techniques, such as an RFID tag or NFC tag may also or instead be used, an optically encoded and machine-readable identifier advantageously permits automatic capture and analysis of the cartridge identifier using the camera (or other imaging system) and processor already present in the imaging system.

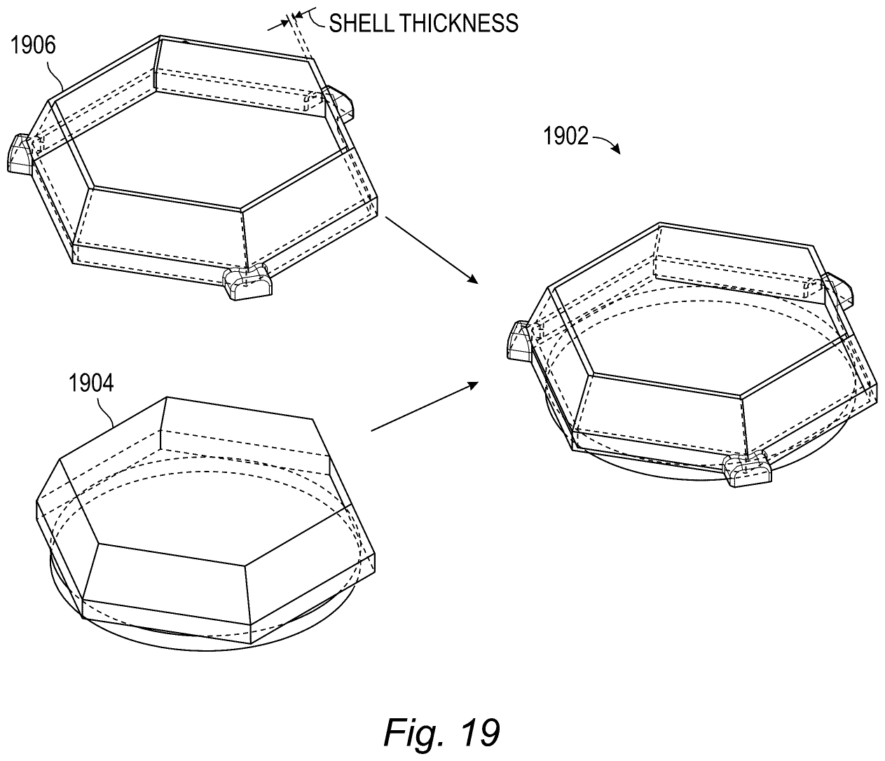

FIG. 19 shows an overmolded design for an imaging cartridge. In general, an imaging cartridge 1902 such as any of the imaging cartridges described herein may include a substrate 1904 overmolded with an outer layer 1906. In general, the substrate may be any suitably rigid and optically clear material. The outer layer 1906 is preferably formed of the same material, but with a different optical density to provide an absorbing layer with an engineered transmission. For example, the substrate 1904 may be formed of an optically clear polymethyl methacrylate (PMMA), and the outer layer 1906 may be formed of PMMA with an optical density of about 0.5 to about 1.0. In this configuration, the outer layer 1906 will absorb light in a manner that scatters incident light without created substantial refraction or total internal reflection. While various geometries are possible for the substrate 1904, the outer layer 1906 will preferably cover the sides and top to control illumination within and through the substrate. As a significant advantage, an imaging cartridge configured in this manner can diffuse light from an illumination source (to support illumination of the entire imaging field of view) while reducing stray light scattering inside the imaging volume.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared, or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A device comprising:
an imaging volume defining a three-dimensional field of view for capturing images;
a camera having an imaging axis passing through the imaging volume;
a plane intersecting the imaging volume and perpendicular to the imaging axis of the imaging device;
a laser providing illumination including fixed-focus, coherent light;
a diffractive optical element positioned to receive the illumination from the laser on a first surface, the first surface of the diffractive optical element including micropatterned structures to create a three-dimensional illumination pattern within the imaging volume from a second surface opposing the first surface;
a liquid lens configured to focus the camera on a target surface of an object within the imaging volume;
an imaging cartridge removably and replaceably coupled to the device, the imaging cartridge including a rigid substrate and an optical element having a soft, optically clear elastomer on a first side facing the camera and a thin, reflective coating on a second side opposing the camera; and
a processor configured by instructions stored in a memory to receive an image of light from the pattern reflected by the thin, reflective coating of the elastomeric optical element as it deforms to the surface of the object within the imaging volume, the processor further configured by instructions stored in the memory to calculate a quantitative surface topography of the surface based on the image.

2. A device comprising:
an imaging volume within a conformable imaging medium defining a three-dimensional field of view for capturing images;
an imaging device having an imaging axis passing through the imaging volume;
a plane intersecting the imaging volume and perpendicular to the imaging axis of the imaging device;
a light source providing illumination; and
an optical element positioned and structured to receive the illumination from the light source on a first surface and create a pattern within the imaging volume from a second surface opposing the first surface, the second surface at an angle to the plane intersecting the imaging volume.

3. The device of claim 2, wherein the optical element includes a diffractive optical element, the device further comprising a second diffractive optical element positioned and structured to create a second pattern within the imaging volume for a different location about a perimeter of the imaging volume than the diffractive optical element.

4. The device of claim 2, further comprising a processor configured to receive an image of light from the pattern reflected by a surface within the three-dimensional field of view and to calculate a quantitative surface topography of the surface based on the image.

5. The device of claim 4, wherein the surface includes a deformable surface of the conformable imaging medium intersecting the imaging volume.

6. The device of claim 2, further comprising a multi-view imaging system configured to calculate a quantitative surface topography of a surface within the three-dimensional field of view based on images of the surface from two or more different perspectives.

7. The device of claim 2, further comprising a multi-view imaging system that resolves a three-dimensional shape of the surface using a second spectral band having wavelengths non-overlapping with a first spectral band of the light source.

8. The device of claim 7, further comprising a second light source providing illumination in the second spectral band.

9. The device of claim 2, further comprising an imaging cartridge positioned at least partially within the imaging volume, the imaging cartridge including the conformable imaging medium on a first side facing the imaging device and an optical coating on a second side opposing the imaging device.

10. The device of claim 9, wherein the conformable imaging medium includes a soft, optically clear elastomer.

11. The device of claim 2, further comprising an imaging cartridge including a retrographic sensor positioned within the imaging volume.

12. The device of claim 2, further comprising an imaging cartridge including an elastomeric optical element positioned within the imaging volume.

13. The device of claim 2, further comprising a liquid lens configured to focus the imaging device on a surface within the imaging volume.

14. The device of claim 2, further comprising a lens configured to change a focus along the imaging axis through the imaging volume.

15. The device of claim 2, wherein the optical element includes a diffractive optical element having micropatterned structures configured to create the pattern within the imaging volume from the light from the light source incident on the first surface.

16. The device of claim 2, wherein the optical element includes metasurfaces configured to create the pattern within the imaging volume from the light incident on the first surface.

17. The device of claim 2, wherein the pattern includes a three-dimensional pattern varying along the imaging axis within the imaging volume.

18. The device of claim 2, wherein the pattern includes a first plurality of features closely spaced within the plane and a second plurality of features visually distinguishable from the first plurality of features and more distantly spaced within the plane.

19. The device of claim 2, wherein the pattern includes a first plurality of features and a second plurality of features collectively forming a regular geometric pattern within the plane, the second plurality of features forming visually distinguishable anchor points within the pattern.

20. The device of claim 2, wherein the pattern includes a first plurality of features closely spaced to provide high resolution detection of depth within the imaging volume and a second plurality of features placed sufficiently far apart within the plane through the imaging volume avoid intersections along the imaging axis within the imaging volume during a maximum expected deformation of a contact surface of an elastomeric optical element within the imaging volume.
